(19) United States
(12) Patent Application Publication
(10) Pub. No.: US 2024/0380761 A1
(43) Pub. Date: Nov. 14, 2024

(54) MACHINE LEARNING BASED APPROACH TO DETECT STEALTHY COMMAND AND CONTROL NETWORK COMMUNICATIONS

(71) Applicant: George Mason University, Fairfax, VA (US)

(72) Inventors: Xinyuan Wang, McLean, VA (US); Fabian Martin Ramos, Washington, DC (US)

(73) Assignee: George Mason University, Fairfax, VA (US)

(21) Appl. No.: 18/659,680

(22) Filed: May 9, 2024

Related U.S. Application Data
(60) Provisional application No. 63/501,165, filed on May 10, 2023.

(51) Int. Cl. H04L 9/40

(52) U.S. Cl. CPC H04L 63/1416

(57) ABSTRACT

A method, system and apparatus provides detection of malicious network traffic by analyzing, via a trained machine learning model, at least timing and flow duration features of extracted from monitored network traffic, the at least timing and flow duration features independent of content of the monitored network traffic; and predicting, via the trained machine learning model, from the analyzed at least timing and flow duration features that a cyber-attack has occurred or is occurring.

### PRIORITY CLAIM

This application claims the benefit of provisional application Ser. No. 63/501,165 filed May 10, 2023 and titled “Detecting and Blocking Stealthy Command and Control Communications,” the entire content of which is hereby incorporated by reference.

### BRIEF DESCRIPTION OF THE DRAWINGS

The accompanying drawings provide visual representations which will be used to describe various representative embodiments more fully and can be used by those skilled in the art to understand better the representative embodiments disclosed and their inherent advantages. In these drawings, like reference numerals identify corresponding or analogous elements.

FIG. 1 depicts packet capture from HTTPS Beacon transactions, in accordance with various representative embodiments of the present disclosure.

FIG. 2 illustrates captured HTTPS packets from normal network traffic, in accordance with various representative embodiments of the present disclosure.

FIG. 3 illustrates a flow chart for detecting malicious network traffic, in accordance with various representative embodiments of the present disclosure.

FIG. 4 illustrates a further flow chart for detecting malicious network traffic, in accordance with various representative embodiments of the present disclosure.

FIG. 5 illustrates a block diagram of a network having a cyber-attack detection system, in accordance with the various representative embodiments of the present disclosure.

FIG. 6 illustrates a block diagram of a network having a Cobalt Strike cyber-attack detection system, in accordance with the various representative embodiments of the present disclosure.

FIG. 7 illustrates a block diagram of a cyber-attack detection system for use in a network is shown, in accordance with various representative embodiments of the present disclosure.

FIG. 8 illustrates an example controller and/or computing environment in which aspects of some of the embodiments of the present disclosure may be implemented, in accordance with various representative embodiments of the present disclosure.

FIG. 9 depicts comparison of performance of example machine learning models, in accordance with various representative embodiments of the present disclosure.

FIG. 10 depicts an example confusion matrix of a random forest machine learning model, in accordance with various representative embodiments of the present disclosure.

### DETAILED DESCRIPTION OF EMBODIMENTS

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

As society has become increasingly dependent on digital technologies, cyber-attacks have become a more serious threat to critical systems and infrastructures. Recent massive data breach attacks on various business organizations and government agencies have impacted tens or hundreds of millions of people. Now cybercriminals can launch sophisticated attacks and compromise mission critical systems via the Internet from virtually anywhere in the world. By using covert command & control (C&C) channels, cybercriminals can stealthily control compromised systems from thousands of miles away and exfiltrate sensitive data for long periods of time undetected. These types of sophisticated cyber-attacks, called advanced persistent threats (APT), cause prohibitive financial and security losses to businesses, governments and individuals.

Cobalt Strike is a stealthy and powerful command and control (C&C) framework that has been widely used in many recent massive data breach and ransomware attacks. Cobalt Strike has been widely used in recent sophisticated cyber-attacks due to its ability to establish stealthy C&C channels between the victim system and the attacker. Cobalt Strike's stealthy in-memory persistence and C&C channels enable it to surreptitiously explore, identify and exfiltrate highly sensitive information from highly secure information systems without being detected for long periods of time. Specifically, Cobalt Strike C&C traffic is fully encrypted and can mimic legitimate network traffic using communication protocols such as HTTPS, which will defeat any content-based detection.

While detecting Cobalt Strike C&C network traffic is crucial to the protection of critical systems from many sophisticated cyber-attacks, no existing intrusion detection systems have been shown to be able to reliably detect real world Cobalt Strike C&C traffic from encrypted traffic.

The various methods, systems and apparatus described herein provide machine learning-based mechanisms for detecting malicious command and control (C&C) activity in network traffic. As described herein, a machine learning based approach is used to detect stealthy C&C network traffic, such as stealthy Cobalt Strike C&C traffic. Anew innovative approach that detects stealthy Cobalt Strike C&C activities from encrypted traffic is disclosed. Instead of using packet flow content information, machine learning based detection is used with packet timing and flow duration information that are not changed by encryption, such as inter-packet timing, inter-flow timing and payload size. While detection of malicious traffic is described in the context of detecting stealthy Cobalt Strike C&C activities from encrypted traffic, the malicious traffic need not be encrypted and the innovation described herein applies to both encrypted and decrypted network traffic.

Based on the analysis of real-world (actual) Cobalt Strike traffic, an approach using traffic flow-level features that capture the inherent characteristics or features of Cobalt Strike C&C traffic is used to great advantage. Machine learning based detection has been empirically validated with five machine learning algorithms with Cobalt Strike traffic from real-world cyber-attacks. Empirical results demonstrate that a random forest machine learning model, for example, can detect close to 50% of real world Cobalt Strike C&C traces in encrypted traffic with a 1.4% false positive rate as will be described. A naïve Bayes model used herein achieves over 8.4% detection true positive rate with 13% false positive rate.

As described herein, a method of the disclosure provides for detecting malicious network traffic, including analyzing, via a trained machine learning model, at least timing and flow duration features of a number of traffic flow features extracted from monitored network traffic, the at least timing and flow duration features independent of content of the monitored network traffic; and predicting, via the trained machine learning model, from the analyzed at least timing and flow duration features that a cyber-attack has occurred or is occurring.

A further method of the disclosure provides for training a machine learning model used for detection of malicious network traffic, including evaluating machine learning models based on performance metrics of timing and flow duration features of traffic flow features extracted from monitored network traffic and analyzed, the evaluating including determining for each of the machine learning models evaluated at least a true positive rate (TPR) metric and a false positive rate (FPR) metric; selecting a machine learning model of the machine learning models having a favorable performance metric of the performance metrics including a favorable ratio of the true positive rate (TPR) to the false positive rate (FPR); and training the selected machine learning model on a training dataset to generate the trained machine learning model.

A detection system for detecting malicious network traffic includes: an analyzer configured to analyze, via a trained machine learning model, at least timing and flow duration features of a plurality of traffic flow features extracted from monitored network traffic, the at least timing and flow duration features independent of content of the monitored network traffic; and a predictor configured predict, via the trained machine learning model, from the analyzed at least timing and flow duration features of the plurality of traffic flow features that a cyber-attack has occurred or is occurring.

### Cobalt Strike Overview

Cobalt Strike is a powerful and stealthy command and control (C&C) framework that allows attackers to 1) perform target reconnaissance by identifying known vulnerabilities in software versions; 2) create trojans and malicious website clones that enable drive-by attacks; 3) deploy and inject malicious agents called Beacons into vulnerable targets (Hosts); 4) perform tasks in systems infected with a Beacon, such as log keystrokes, take screenshots, execute commands, download additional malware or inject a Beacon in other processes; and 5) disguise its C&C traffic using encryption and mimic normal network traffic using communication protocols such as HTTP, HTTPS or Domain Name System (DNS) to surpass cybersecurity defenses. Due to its post-exploitation and stealthy C&C features, Cobalt Strike has been widely used in sophisticated cyber-attacks.

Cobalt Strike has two main components: the team server and the client. The team server is the C&C server that interacts with a victim or victim system that has been infected with a Beacon, and it also accepts client connections. The client is the system used by the attacker to interact with the team server to send commands to the Beacons. Cobalt Strike Beacon is the malware payload used by Cobalt Strike to create a backdoor on a victim system that connects to the team server and can be divided into two parts: the payload stage and the payload stager. The payload stager is a smaller program that is used to download the payload stage on to a system, inject it into memory, and pass the execution to it. The payload stage is the actual backdoor that runs in memory and can establish a connection to the C&C server through different channels. As used herein, victim and victim system may be used interchangeably.

Cobalt Strike contains many additional components, including Listeners, Arsenal Kits and Malleable C&C profiles, which allow it to be configured to bypass defense systems. Listeners define how the Beacon connects to the team server, such as the IP address of the C&C server, the ports and the protocol used. Cobalt Strike supports a great variety of protocols: HTTP, HTTPS and DNS are the most popular ones, while also supporting SMB, raw TCP, foreign listeners (using Metasploit's Meterpeter, for example) and external C&C listeners.

Arsenal Kits allow additional customization into Cobalt Strike capabilities to evade antivirus products. Some of the most popular kits include: Artifact kit that allows attackers to modify the template for all Cobalt Strike executables, Dynamic Linked Libraries (DLLs) and shellcode; Elevate kit that allows attackers to include third-party privilege escalation scripts with Cobalt Strike Beacon; and Mimikatz kit that allows attackers to use and update the Mimikatz installation included with Cobalt Strike. Malleable C&C profiles, part of the Arsenal Kit, allow the attacker to customize the communications between the Beacon and the team server as well as the Beacon in-memory characteristics, to determine how injections are processed, and to influence post-exploitation jobs.

The Malleable C&C profiles' ability to customize the network traffic that the Beacon generates and receives, such as the interval between each Beacon callback to the team server, the URI of the HTTP/S requests, inserting additional data to masquerade the actual data payload size and more, is a main characteristic that makes Cobalt Strike such a powerful tool for penetration testers and malicious agents alike. These characteristics allow the attacker to blend the C&C malicious traffic with normal traffic, bypassing security defenses such as network firewalls and intrusion detection systems.

### Cobalt Strike C&C Communications

This disclosure describes detection of the two most popular application level protocols used by attackers for Cobalt Strike C&C communications: Hypertext Transfer Protocol (HTTP) and Hypertext Transfer Protocol Secure (HTTPS). A typical Cobalt Strike C&C HTTP or HTTPS transaction between an infected host and the C&C server may proceed as follows. First, the TCP connection is established via the TCP three-way handshake (SYN, SYN/ACK, ACK). If the HTTPS protocol is used, the Transport Layer Security (TLS) handshake is performed (Client Hello, Server Hello, Server Key Exchange, Client Key Exchange, Finished) to establish the HTTPS session. Then, the exchange of data takes place between the victim and the team server. Finally, the HTTPS session and TCP connection are closed. The Beacon performs callbacks to the C&C server periodically to retrieve tasks to execute, sending the information of the infected system in a GET request after the connection has been established. The server responds to the request with the tasks, if any have been instructed by the attacker. The Beacon then executes the tasks and initiates another connection to send the output back to the C&C server using a POST request. The server then responds with data that is discarded by the Beacon. The packet payload is encoded and encrypted to complicate the analysis of its contents by security systems. Cobalt Strike uses this process to simulate a legitimate HTTP/S exchange between a client and a server.

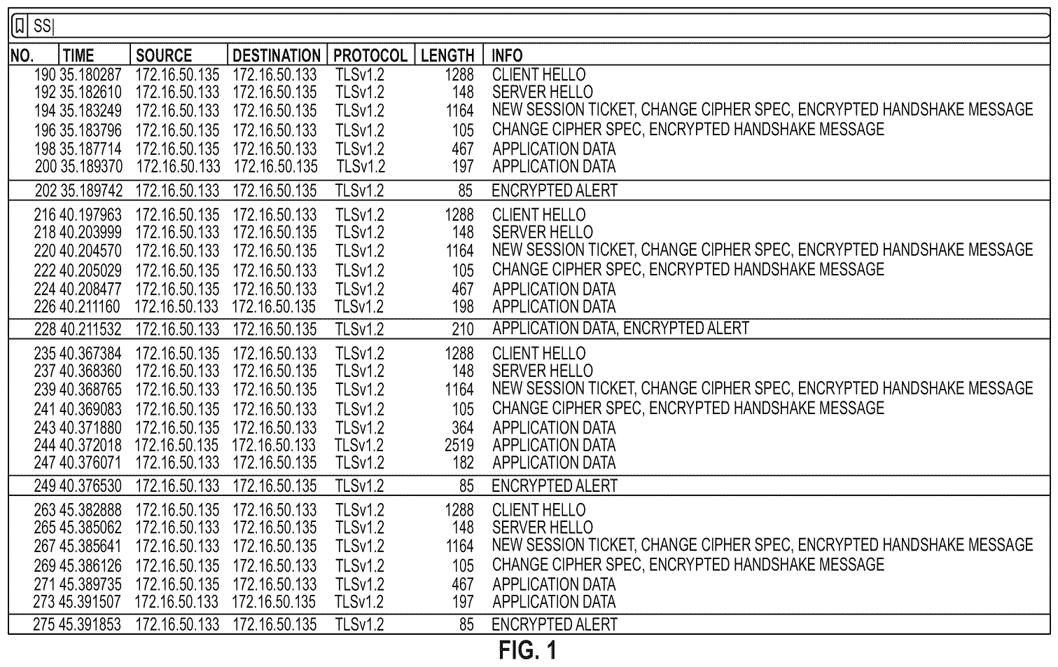

Referring now to FIG. 1, packet capture from HTTPS Beacon transactions are shown, including several HTTPS transactions between a Beacon-infected host and a team server from a packet capture using the network protocol analyzer tool Wireshark, for example. In the image, it is possible to observe that, after establishing the HTTPS session through the TLS Handshake, the victim and the C&C server exchange “Application Data” packets which are used to transmit the tasks that are to be executed to the Beacon or send the results from those tasks back to the C&C server. Once the data has been exchanged, the C&C server closes the HTTPS session using an “Encrypted Alert” packet. Each connection between the victim and the team server requires the client to open a new HTTPS session with the server.

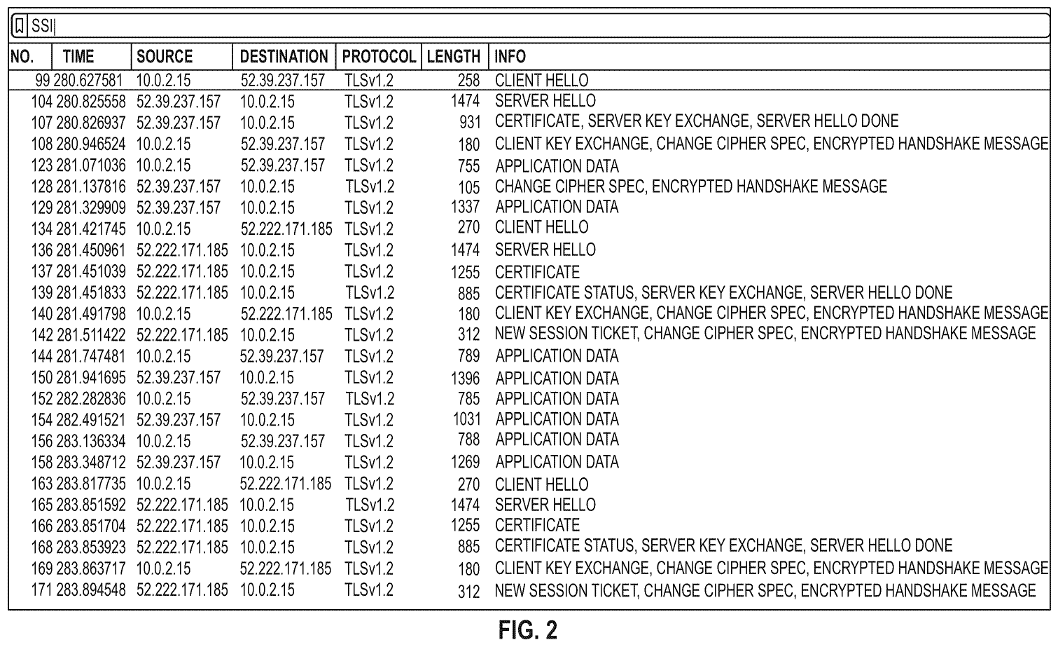

Referring now to FIG. 2, a packet of legitimate HTTPS traffic such as when accessing a web page is shown. Comparing FIG. 1 with FIG. 2, notable differences between legitimate traffic and Beacon traffic are observed. First, the Beacon does not use the same TCP connection to contact the C&C server more than once. This event occurs for both the HTTP and HTTPS Beacons, but it can be more clearly observed in the case of the HTTPS Beacon: the C&C server sends an “Encrypted Alert” packet indicating that the HTTPS session is closed, and consequently also closes the TCP connection shortly after that packet is sent. Therefore, as can also be observed in FIG. 1, the Beacon opens a TCP connection for every call to the C&C server and closes it after retrieving the required tasks or sending the information back.

Thus, unless more than one Beacon is used to infect a system and the Beacons are communicating with the same server simultaneously, it is not possible to observe the case of two consecutive TCP connections being made from the victim to the C&C server without the previous connection being closed; it is a common occurrence in legitimate traffic to have multiple TCP connections simultaneously between the client and the server.

Furthermore, the duration of a TCP connection between a legitimate client and a server tends to be longer than a Beacon connection. In a Beacon transaction only a few packets are exchanged, especially when the transaction is the Beacon receiving the tasks. The exfiltration of data from the infected system can also be used to detect the Beacon traffic, since legitimate traffic rarely requires the client to send great quantities of data to the server.

### Cobalt Strike Malleable C&C Profiles

Cobalt Strike introduces the use of Malleable C&C profiles to customize the network indicators of the C&C traffic between the Beacon and the team server as an evasion measure, as they can be used to disguise Beacon traffic to look like other malware or blend-in with legitimate traffic, making detection difficult. The Malleable C&C profiles are loaded onto the team server and modify the in-memory characteristics of the Beacon, directing how to transform and store the data in a transaction and post-exploitation functions.

The Malleable C&C profile is structured into several sections which are used to configure the global Beacon behavior or specific behavior depending on the communication protocol used. The global configuration includes the sleep time which is the Beacon callback interval, the data jitter which is a random length string up to the chosen value (in bytes) that is appended to the server value, and the user agent which sets the User-Agent string used in the HTTP requests to identify the application, operating system, vendor and version of the requesting computer program.

The Malleable C&C profile can also be used to configure the HTTP headers, the SSL certificate used in HTTPS sessions, the URI of HTTP requests, the HTTP verb used in the transactions and the modifications performed to the payload of the packets sent from the server and the Beacon, including appended data and encoding.

Analysis of the HTTP/S Cobalt Strike traffic and the Malleable C&C profiles has identified several network indicators that can be used to detect the Cobalt Strike C&C traffic: 1) the Beacon sleeps for an interval of time after not receiving tasks or after sending the output to the server; 2) most of the communications (sessions) have a short duration and few data packets are exchanged; and 3) in most cases the victim sends more data to the C&C server than the opposite, especially when Cobalt Strike is exfiltrating information about the victim.

### Machine Learning Based Detection—Threat Model

A machine learning based detection system that can identify and detect stealthy Cobalt Strike C&C activity from network traffic, both detected and undetected, in near real-time is disclosed. In accordance with certain embodiments discussed herein, several assumptions are made, including: that the system has already been infected with a Cobalt Strike Beacon and that the initial infection has not been detected by IDS/IPS; that the Cobalt Strike Beacon initiates the communications with the C&C server after completing the download of the Beacon payload; that the attackers use encryption and customized Cobalt Strike Malleable C&C profiles to mimic legitimate traffic and evade detection. Consequently, the C&C packets exchanged do not have any fixed pattern.

### Machine Learning Based Detection—Flow Based Features

In order to detect Cobalt Strike C&C traffic amongst legitimate traffic, traffic analysis software or framework tool Zeek, for example, is used to extract the network indicators of the individual flows or connections. Zeek produces a record for each connection that has occurred with a system in the log file conn.log in real-time, but it can also be used to analyze packet captures and output the connections within. While a connection is usually associated with the TCP protocol, Zeek can also track stateless protocols like (UDP). The flow-related features, referred to herein as traffic flow features, that are selected from the Zeek output may include the following:
id.orig_h: string. IP address of the host that initiated the connection, e.g. the Cobalt Strike Beacon.
id.orig_p: integer. Port used by the host that initiated the connection.
id.resp_h: string. IP address of the host that received the connection, e.g. the Victim.
id.resp_p: integer. Port used by the host that received the connection.
proto: string. The transport layer protocol of the connection, such as TCP, UDP, Internet Control Message Protocol (ICMP).
service: string. Identification of an application protocol sent over the connection, such as DNS, HTTP, HTTPS, etc.
duration_index: double. The total duration of the connection.
orig_bytes: integer. Payload bytes that the originator of the connection, i.e. the host that initiated the connection, sent.
resp_bytes: integer. Payload bytes that the responder, e.g. the host that received the connection, sent.
conn_state: string. State of the connection, some typical values include SHR (responder sent SYN ACK followed by SYN) and S0 (connection attempt seen).
history: string. Records the state history of connections as a string of letters.
orig_pkts: integer. Number of packets that the originator sent during the connection.
orig_ip_bytes: integer. Number of IP level bytes that the originator sent during the connection.
resp_pkts: integer. Number of packets that the responder sent during the connection.
resp_ip_bytes: integer. Number of IP level bytes that the responder sent during the connection.

Traffic flow features such as the IP addresses and ports of the sender and the receiver of the connection are useful to identify the connections, but cannot be used in the detection process. Other traffic flow features such as the protocol, duration of the connection, packets and bytes exchanged that describe inter-packet timing, inter-flow timing and payload size are used by the machine learning model to make the predictions on the traffic, based on the analysis of the Cobalt Strike C&C traffic. While Zeek is described in a representative example embodiment, other network analysis tools may also be used to extract traffic flow features from monitored network traffic.

### Machine Learning Based Detection—Machine Learning Models

In order to select the machine learning algorithms that may be used to develop the model, an assessment indicates which algorithms best tackle the problem at hand. Since the goal of the model is to make predictions on the network traffic to determine if a system has been infected with a Cobalt Strike Beacon, one can identify it as a binary classification problem. However, since a system being infected with Cobalt Strike is considered an abnormal event due to its rare occurrence probability, it can also be identified as an anomaly detection problem, even if the Beacon traffic flow features do not differ significantly from the legitimate traffic, as its purpose it to disguise itself as such. The training dataset records will be labeled, thus both supervised and unsupervised anomaly detection analysis can be performed. However, as will be described, the unsupervised model will obtain worse results due to the similarity in feature values that the Beacon and the legitimate traffic have.

The following machine learning algorithms have been evaluated to generate the model: random forest, artificial neural network, linear support vector machine and naïve Bayes for the supervised model, and K-Means clustering algorithm for the unsupervised model.

### Machine Learning Based Detection—Evaluation Metrics

A variety of metrics are used to objectively evaluate the different machine learning algorithms that may be used to generate the model that will make predictions on network traffic to discover if a system has been infected with a Cobalt Strike Beacon.

A confusion matrix is a table used to describe the performance of a machine learning model when performing classification tasks over a test dataset whose labels (or classes) are known. It does so by establishing a relationship between the real label of a record and the predicted label of the same record, thus graphically exposing the number of records that have been correctly and incorrectly classified.

Independently of the number of labels in the dataset, the confusion matrix outputs four values for each label. For a specific label, the number of true positives (TP) is the number of records corresponding to that label that have been correctly classified as such. The number of false negatives (FN) is the number of records corresponding to the label that have been misclassified as belonging to other labels. The number of false positives (FP) indicates the number of records belonging to different labels that have been misclassified as belonging to the chosen label. Last, the number of true negatives (TN) is the number of records that have been correctly classified as belonging to other labels. In the case of this disclosure, the positive label will refer to the Beacon traffic, while the legitimate traffic will be labeled as negative. Other conventions may be employed without departing from the scope of the disclosure.

Using the output of the confusion matrix, it is possible to calculate the following metrics to evaluate the machine learning algorithms:
Accuracy: Ratio between the number of correct predictions and the total number of predictions made. It is the best indicator of the algorithm's performance only if the dataset has the same number of records for each class.

$$Accuracy = \frac{TP + TN}{TP + FP + TN + FN} \qquad ( 1 )$$

Precision: The precision is the ratio between the number of correct predictions for a class and the total number of predictions of said class. The weighted precision is used to evaluate the model for all classes, calculating a weighted average depending on the probability of occurrence of each class.

$$Precision = \frac{TP}{TP + FP} \qquad ( 2 )$$

Recall or True Positive Rate (TPR): Proportion of positive records correctly classified as such compared to the total number of positive records.
   It can be considered a percentage. Similarly to the precision analysis, the weighted recall for all the labels is considered.

$$TPR = \frac{TP}{TP + FN} \qquad ( 3 )$$

False Positive Rate (FPR): Proportion of negative records incorrectly classified as positive records, with respect to all negative records. It can be considered a percentage.

$$FPR = \frac{FP}{FP + TN} \qquad ( 4 )$$

F1 score: Measures the performance of a model by considering both its precision as well as its robustness. To do so, it uses the Precision and Recall values.

$$F 1 = 2 \text{?} \frac{Precision \text{?} Recall}{Precision + Recall} \qquad ( 5 )$$

$$\text{?} \text{indicates text missing or illegible when filed}$$

When evaluating the model certain evaluation metrics may be more important than others. Such is the case of the true positive rate or TPR, which will indicate the model's ability to correctly detect the Beacon traffic. The false positive rate or FPR is used to evaluate the adequacy of the model to be deployed in a real environment; as most of the network traffic that an intrusion detection system analyzes is legitimate, a low rate of false alarms is required for its deployment. For example, if a detection system is deployed in a real environment that will potentially see hundreds of thousands to millions of connections, a high false positive rate will cause disruptions in the legitimate activity of the users of the network, as tens of thousands of legitimate connections will be detected as malicious. Finally, the F1 score will provide overall information about the model's accuracy and robustness.

### Empirical Validation: Dataset Acquisition

The machine learning based detection requires a training dataset to develop the machine learning model and a testing dataset to evaluate the performance of the model. Both datasets contain legitimate traffic and Cobalt Strike C&C traffic, so that the machine learning model is developed and evaluated using traffic that is closely related to the traffic that would be found in a real life environment.

The legitimate traffic may be obtained from the popular cybersecurity dataset CICIDS17 of the Canadian Institute of Cybersecurity and the public CTU-Normal-20 dataset of the Stratosphere Research Laboratory, as an example. For the training dataset, 31 Cobalt Strike C&C packet captures (PCAP) are generated and collected using different Malleable C&C profiles that emulate advanced penetration threats (APT), crimeware, normal traffic, or generated using randomizers. The use of different Malleable C&C profiles and commands reduces the possibility of overfitting the machine learning model to a specific profile, thus enabling the machine learning models to perform better in the presence of previously unseen real world Cobalt Strike traffic. The testing dataset, on the other hand, has been generated using 25 captured traces of real world cyber-attacks that include Cobalt Strike C&C traffic, such as from malware-trafficanalysis.net, for example. All the Cobalt Strike traffic in these traces has been manually labeled by cybersecurity teams, which enables measurement of the performance of machine learning based detection.

Each record and its features in the dataset corresponds to an individual flow or connection in the network, which has been extracted from the acquired traffic using the network analysis tool Zeek. Each record has been labeled using an additional feature, label, which will take two values in an example embodiment: 1 if the record corresponds to Cobalt Strike Beacon traffic, and 0 if the record corresponds to other types of traffic—legitimate or unknown: some of the test captures may contain malicious traffic generated from other malware.

Table 1 shows a resulting record distribution of the datasets for each of the labels in a representative example. Given that Cobalt Strike C&C traffic is very rare in the real world, the training dataset is deliberately built with significantly more legitimate traffic records than Beacon traffic records. Such a training dataset not only enables the machine learning model to detect Cobalt Strike activities in real world scenarios, but also helps reduce potential detection false positives generated by the model. The percentage of Beacon records, which is around 2% of all the records in the training dataset, is a lower than average percentage for most cybersecurity datasets, but it is enough for most models to be able to detect the Beacon traffic generated using different Malleable C&C profiles and also correctly identify the legitimate traffic producing a low rate of false alarms.

TABLE 1
Dataset Content

| | Cobalt Strike | Cobalt Strike | Legitimate |
|---|---|---|---|
| | (HTTP) | (HTTPS) | HTTPS |
| Training | 5,500 records | 4,000 records | 391,500 records |
| dataset | | | |
| Testing | 450 records | 3,150 records | 10,800 records |
| dataset | | | |

### Flow Based Machine Learning Detection

First, the traffic flow features are selected from the raw dataset that will be used in the detection of the network traffic. Each record belonging to the dataset has 14 traffic flow features out of which four (4) of those features (id.orig_h, id.orig_p, id.resp_h and id.resp_p) need only be used for identification purposes. The IP addresses and ports used in the connection communications need not be used to detect the Beacon traffic, as they are network indicators that can easily be changed by the attacker, thus evading the detection system. As described herein, at least at least timing and flow duration features of a number of traffic flow features that provide information on inter-packet timing, inter-flow timing and payload size are useful to detect a cyber-attack.

Since in certain example embodiments the machine learning model focuses on the detection of HTTP/S Beacons, which use the TCP protocol in the transport layer, the proto and service traffic flow features may be needed in the identification of the Beacon traffic. The state of the connection traffic flow feature, conn state, need not be selected in these embodiments because it will not help in the identification of the Beacon traffic, since it only identifies if the connection has correctly finished or not and most if not all the records in the dataset have the same value for the connection. On the contrary, the duration of the connection duration traffic flow feature will be used in the detection of the Beacon traffic in these example embodiments because the duration of the connection between the first host that initiated the connection and a second host that received the connection can vary due to external factors such as network latency and packet drops regardless of the type of traffic.

The history traffic flow feature, extracted by Zeek or another network analysis tool, records the “history” of the transactions in the connection such as the type of packets that were transmitted, the order in which the packets were sent, and who sent the packets by using letters. Therefore, based on the analysis of the Beacon traffic performed previously discussed, one can assume that the history traffic flow feature will have similar values for the connections made by the Beacon traffic, as it always follows the same general schema of communications. The selection of the rest of the traffic flow features (orig_bytes, resp_bytes, orig_pkts, orig_ip_bytes, resp_pkts, resp_ip_bytes) may be done alongside the evaluation of the model, depending on how they affect the performance of the model.

Since several traffic flow features selected contain categorical data, such as proto, service and history more precisely, it may be necessary to perform feature encoding to transform their values to numerical data. To do so, the traffic flow features' values are transformed from string to integer by assigning an integer value to each distinct string value according to the frequency of appearance of the value and generating an additional traffic flow feature with “_index” in the name. If a string value appears for the first time in the testing dataset, it may be assigned the same value as the least frequent value.

The hyperparameter tuning phase has been performed using the results from the machine learning model evaluation for their respective algorithms. However, all the tested values for the tuning phase need not be explained, since most experiments regarding the hyperparameter tuning phase provide little information, as they include manual changes to the hyperparameter values that improve the performance of the models by less than 1% on most occasions.

The random forest model has been generated using proto index, service_index, history_index, orig_bytes, resp_bytes, orig_pkts, orig_ip_bytes and resp_pkts as input traffic flow features, and the hyperparameters values of a maximum depth of 15 and 30 trees created. Observably, the random forest model achieves a moderately good detection rate (around 50%) and a low false alarm rate of 1.4%. On the other hand, the neural network model achieves poor detection results with a 3% detection rate but a low false alarm rate of 0.3%. The neural network model has been built using a four-layer structure, using two hidden layers with 18 nodes each, taking the 9 selected traffic flow features as inputs (proto_index, service_index, history_index, orig_bytes, resp_bytes, orig_pkts, orig_ip_bytes, resp_pkts and resp_ip_bytes) and utilizes the L-BFGS solver.

The naïve Bayes model and the linear support vector machine achieve higher detection rate than the random forest, at the expense of the false positive rate. The naïve Bayes model takes proto index, service_index, history_index, orig_bytes and orig_pkts as input traffic flow features and using a multinomial model. While obtaining a high true positive rate at 8.4%, it does not serve a real intrusion detection system due to having a 13% false positive rate. Similarly, the linear support vector machine uses three input traffic flow features proto index, service_index, history_index and an aggregation depth of 4 achieving a 100% detection rate but misclassifying 56% of the legitimate traffic. Finally, the unsupervised clustering machine learning model K-means attempts to group the Beacon and legitimate traffic in two separate clusters using the same input traffic flow features as the linear support vector machine model, but ultimately fails to do so, obtaining a 0.4% true positive rate and a 12% false negative rate.

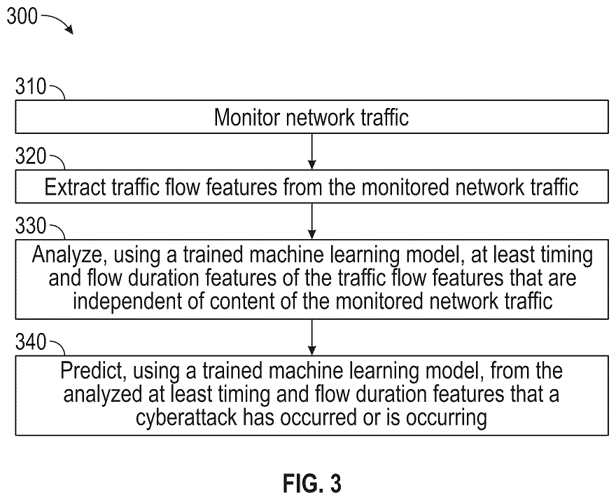

Now therefore, in view of the description above, reference is made to FIG. 3 in which a flow chart 300 for detecting malicious network traffic is depicted, in accordance with various representative embodiments of the present disclosure. At block 310, network traffic is monitored so that traffic flow features may be extracted at block 320. These traffic flow features, including at least timing and flow duration features, may be used in real time or saved for future retrieval and use. At block 330, a trained machine learning model is used to analyze at least the timing and flow duration features that are independent of the content of the monitored network traffic. As discussed, the at least timing and flow duration features analyzed for each connection between a first, originating host and a second, receiving host of a number of connections may include a duration of the connection, exfiltration of the second host compared to the first host during the connection, and interval timing of activity of the first host during the connection. Further, other traffic flow features to be analyzed may include for each analyzed connection: a connection state of the connection to determine the interval timing of activity of the first host during the connection, a transport layer protocol of the connection, an identification of an application protocol sent over the connection, first payload bytes sent by the first host, second payload bytes sent by the second host, a state history of connections between the first host and the second host, a first number of packets sent by the first host, a second number of packets sent by the second host, a first number of IP level bytes sent by the first host, and a second number of IP level bytes sent by the second host. At block 340, from the analyzed traffic flow features, including at least the timing and flow duration features, the trained machine learning model can predict whether a cyber-attack has occurred or is occurring.

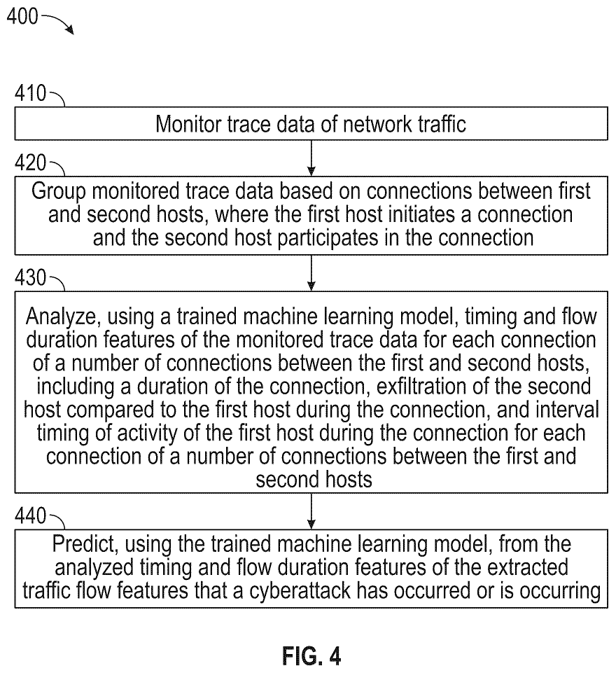

FIG. 4 illustrates a further flow chart 400 for detecting malicious network traffic, in accordance with various representative embodiments of the present disclosure. In this more detailed flow, trace data of the network traffic is monitored at block 410. The monitored trace data may be used in real-time or it may be saved in a database, for example, or other memory for later retrieval and usage. At block 420, the monitored trace data is grouped based on connections between first and second hots, where the first host initiates a connection (such as a Cobalt Strike Beacon) and the second host (such as a Victim) participates in the initiated connection. At block 430, using a trained machine learning model, the timing and flow duration features of the monitored trace data are analyzed for each connection between the first and second hosts. The analyzed timing and flow duration features include a duration of the connection, exfiltration of the second host compared to the first host during the connection, and interval timing of activity of the first host during the connection. At Block 440, the trained machine learning model predicts based upon analysis of the timing and flow duration features whether a cyber-attack has occurred or is occurring.

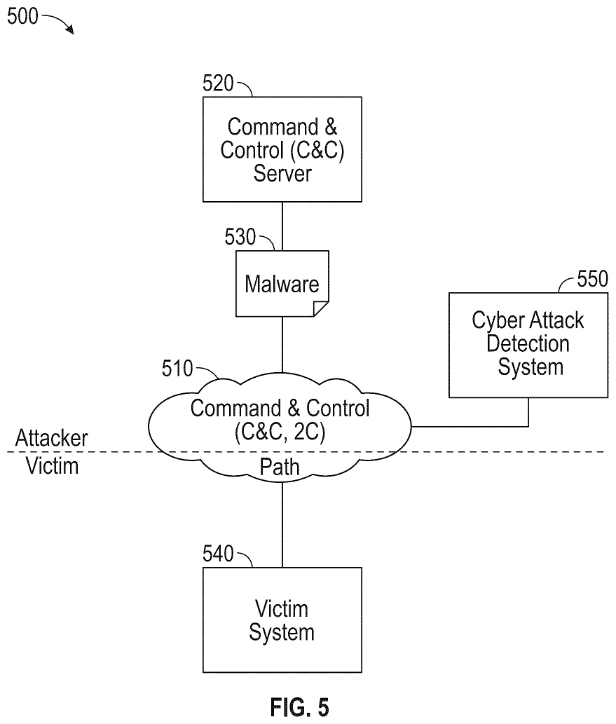

Referring now to FIG. 5, a block diagram 500 of a network having a cyber-attack detection system is shown, in accordance with the various representative embodiments of the present disclosure. As described above, the communication network has command and control (C&C or 2C) pathways 510 that allow communication on the network between an attacker and a victim. The attacker has a C&C server 520 that sends stealthy communications, such as malware 530 across 510 in search of a victim or victim system 540. In accordance with embodiments described herein, cyber-attack detection system is able to detect the occurrence in the past or in real-time of a cyber-attack by C&C server 520 on Victim system 520, via a trained machine learning model that analyzes timing and flow duration features of monitored trace data in order to predict a cyber-attack.

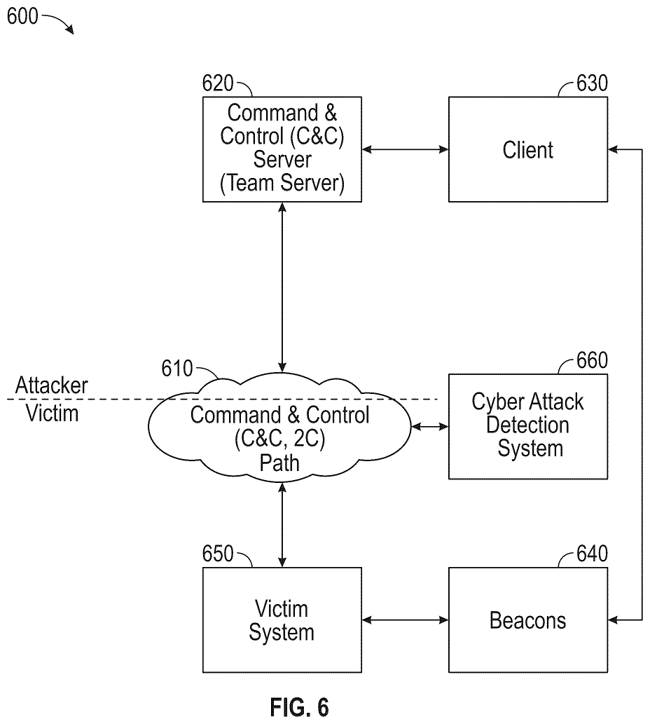

Referring now to FIG. 6, a block diagram 600 of a network having a Cobalt Strike cyber-attack detection system is shown, in accordance with various representative embodiments of the present disclosure. As previously described, a Cobalt Strike C&C framework utilizes a C&C server 620, also referred to as a team server, that communicates and controls a victim or victim system 650 through one or more Beacons 640 in communication with the victim. Cyber-attack detection system 660 uses trained machine learning models to extract good and tainted communications across C&C path 610, analyze timing and flow duration features in order to predict whether a cyber-attack has or is occurring.

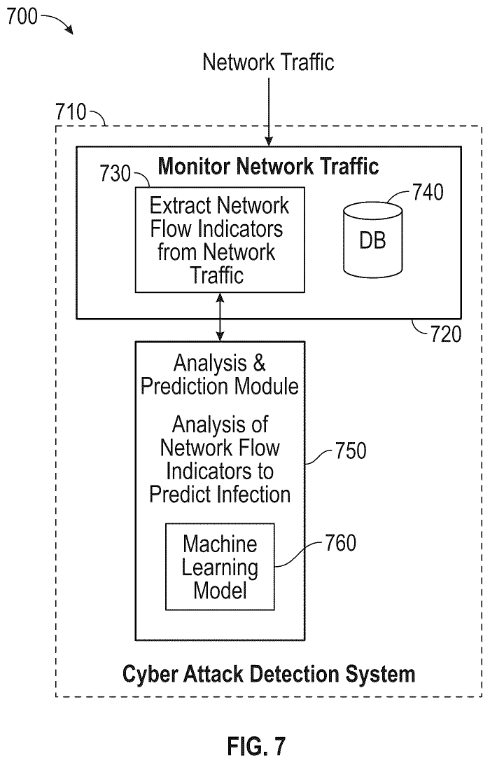

Referring now to FIG. 7, a block diagram 700 of a cyber-attack detection system 710 for use in a network is shown, in accordance with various representative embodiments of the present disclosure. Block 720 monitors network traffic on the network to extract network flow indicators of a number of connections between a first, initiating host and a second, participating host. Of interest for analysis by analyzer and prediction module 750 are those traffic flow features that are independent of the content of the monitored network traffic. As previously described, the extracted network traffic trace data may be used in real-time by analyzer and prediction block 750 or it may be stored in a database 740 or other storage means until needed. Analyzer and prediction module block 750 uses a trained machine learning model 760 to analyze the extracted traffic flow features, including at least timing and flow duration features, and to predict the occurrence of a cyber-attack from the analyzed features.

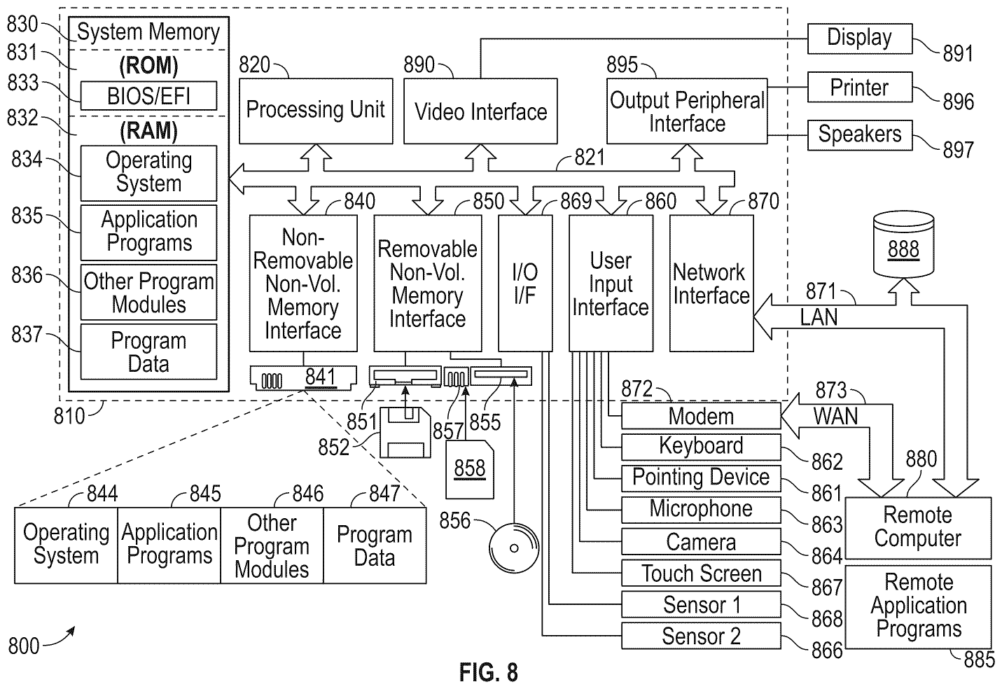

FIG. 8 illustrates an example controller and/or computing environment on which aspects of some embodiments may be implemented. The computing environment 1800 is only one example of a computing environment and is not intended to suggest any limitation as to the scope of use or functionality of the claimed subject matter. Neither should the computing environment 1800 be interpreted as having any dependency or requirement relating to any one or combination of components illustrated in the example operating environment 1800.

Embodiments are operational with numerous other general purpose or special purpose computing system environments or configurations. Examples of well-known computing systems, environments, and/or configurations that may be suitable for use with various embodiments include, but are not limited to, embedded computing systems, personal computers, server computers, mobile devices, hand-held or laptop devices, multiprocessor systems, microprocessor-based systems, set top boxes, programmable consumer electronics, medical device, network PCs, minicomputers, mainframe computers, cloud services, telephonic systems, distributed computing environments that include any of the above systems or devices, and the like.

Embodiments may be described in the general context of computer executable instructions, such as program modules, being executed by computing capable devices. Generally, program modules include routines, programs, objects, components, data structures, etc. that perform particular tasks or implement particular abstract data types. Some embodiments may be designed to be practiced in distributed computing environments where tasks are performed by remote processing devices that are linked through a communications network. In a distributed computing environment, program modules may be located in both local and remote computer storage media including memory storage devices.

With reference to FIG. 8, an example structure and apparatus for implementing some embodiments includes a computing device 810. Components of computing device 810 may include, but are not limited to, a processing unit 820, a system memory 830, and a system bus 821 that couples various system components including the system memory to the processing unit 820. As described herein the computing device may be a sending device, a receiver device, or other user equipment (UE) such as a radio, a smart phone, a cell phone, a transceiver, etc. or any equipment capable of sending and/or receiving messages using an app in an application layer over multiple channels of a communications network.

Computing device 810 may include a variety of computer readable media. Computer readable media may be any available media that can be accessed by computing device 810 and includes both volatile and nonvolatile media, and removable and non-removable media. By way of example, and not limitation, computer readable media may include computer storage media and communication media. Computer storage media may include volatile and/or nonvolatile, and/or removable and/or non-removable media implemented in any method or technology for storage of information such as computer readable instructions, data structures, program modules or other data. Computer storage media includes, but is not limited to, random access memory (RAM), read-only memory (ROM), electrically erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by computing device 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media configured to communicate modulated data signal(s). Combinations of any of the above should also be included within the scope of computer readable media.

System memory 830 includes computer storage media in the form of volatile and/or nonvolatile memory such as ROM 831 and RAM 832. A basic input/output system 833 (BIOS), containing the basic routines that help to transfer information between elements within computing device 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837 that may be stored in RAM 832.

Computing device 810 may also include other removable/non-removable volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, a flash drive reader 857 that reads flash drive 858, and an optical disk drive 855 that reads from or writes to a removable, nonvolatile optical disk 856 such as a Compact Disc Read Only Memory (CD ROM), Digital Versatile Disc (DVD), Blue-ray Disc™ (BD) or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 8 provide storage of computer readable instructions, data structures, program modules and other data for computing device 810. In FIG. 8, for example, hard disk drive 841 is illustrated as storing operating system 844, application programs 845, program data 847, and other program modules 846. Additionally, for example, non-volatile memory may include instructions, for example, to discover and configure IT device(s); to create device neutral user interface command(s); combinations thereof, and/or the like.

A user may enter commands and information into computing device 810 through input devices such as a keyboard 862, a microphone 863, a camera 864, touch screen 867, and a pointing device 861, such as a mouse, trackball or touch pad. These and other input devices are often connected to the processing unit 820 through a user input interface 860 that is coupled to the system bus, but may be connected by other interface and bus structures, such as a parallel port, a game port and/or a universal serial bus (USB).

Sensors, such as sensor 1 868 and sensor 2 866, may be connected to the system bus 821 via an Input/Output Interface (I/O I/F) 869. Examples of sensor(s) 866, 868 include a microphone, an accelerometer, an inertial navigation unit, a piezoelectric crystal, and/or the like. A monitor 891 or other type of display device may also be connected to the system bus 821 via an interface, such as a video interface 890. Other devices, such as, for example, speakers 897 and printer 896 may be connected to the system via peripheral interface 895.

Computing device 810 may be operated in a networked environment using logical connections to one or more remote computers, such as a remote computer 880. The remote computer 880 may be a personal computer, a mobile device, a hand-held device, a server, a router, a network PC, a medical device, a peer device or other common network node, and typically includes many or all of the elements described above relative to computing device 810. The logical connections depicted in FIG. 8 include a local area network (LAN) 871 and a wide area network (WAN) 873, but may also include other networks such as, for example, a cellular network. Such networking environments are commonplace in offices, enterprise-wide computer networks, intranets and the Internet.

When used in a LAN networking environment, computing device 810 may be connected to the LAN 871 through a network interface or adapter 870. When used in a WAN networking environment, computing device 810 typically includes a modem 872 or other means for establishing communications over the WAN 873, such as the Internet. The modem 872, which may be internal or external, may be connected to the system bus 821 via the user input interface 860, or other appropriate mechanism. The modem 872 may be wired or wireless. Examples of wireless devices may include, but are limited to: Wi-Fi, Near-field Communication (NFC) and Bluetooth™. In a networked environment, program modules depicted relative to computing device 810, or portions thereof, may be stored in the remote memory storage device 888. By way of example, and not limitation, FIG. 8 illustrates remote application programs 885 as residing on remote computer 880. It will be appreciated that the network connections shown are exemplary and other means of establishing a communications link between the computers may be used. Additionally, for example, LAN 871 and WAN 873 may provide a network interface to communicate with other distributed infrastructure management device(s); with IT device(s); with users remotely accessing the User Input Interface 860; combinations thereof, and/or the like.

Given the wide spread use of stealthy C&C frameworks, such as Cobalt Strike C&C, in massive data breach and ransomware attacks, it is critically important to be able to detect stealthy C&C traffic in order to effectively mitigate these stealthy and damaging cyber-attacks. As disclosed herein, flow based traffic flow features are used to detect Cobalt Strike Beacon C&C traffic. A variety of machine learning algorithms, including the five machine learning algorithms, are evaluated to develop a machine learning model that can detect the stealth, e.g. Beacon, traffic. As illustrated by the experimental results provided herein, it is feasible to detect real world, previously unseen Cobalt Strike C&C traffic with a reasonable true positive rate and low false alarm rate at the same time.

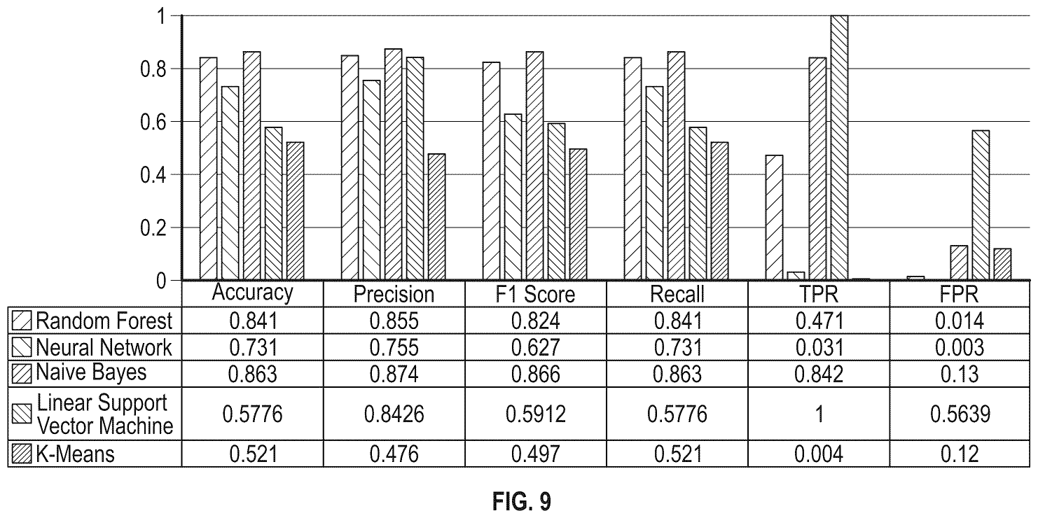

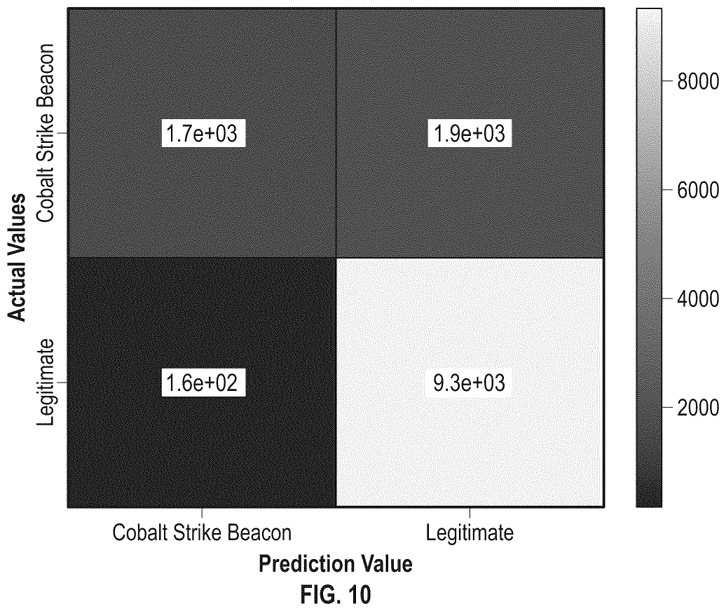

Reference is now made to FIGS. 9 and 10 to illustrate the relative efficacy of various machine learning models. FIG. 9 depicts comparison of performance of example machine learning models, in accordance with various representative embodiments of the present disclosure. As shown in FIG. 9, the random forest and naï\hat{v}e Bayes models perform better than the rest of the models if one considers the F1 score, which considers both the precision and the recall of the models. While the naîve Bayes model achieves a higher F1 score of 86.6% because it detects the Beacon traffic with more accuracy, its high false alarm rate (13%) does not allow its deployment in a real environment that will see a really high percentage of legitimate connections. The random forest model, while having a lower F1 score of 82.4% and having more difficulty detecting Beacon traffic, makes for a better intrusion detection system due to having a false positive rate of 1.4%, as it will produce ten times less false alarms than the naïve Bayes model. Accordingly, a machine learning model that has a favorable ratio of a true positive rate (TPR) to a false positive rate may be chosen to train and generate a trained machine learning model in accordance with embodiments of the present disclosure.

FIG. 10 depicts an example confusion matrix of a random forest machine learning model, in accordance with various representative embodiments of the present disclosure. Referring to the drawing, FIG. 10 shows the confusion matrix of the random forest model when tested against real traffic from Cobalt Strike attacks that include HTTP and HTTPS Beacon traffic, normal traffic, and malicious traffic from other malware sources. Since the focus of this work is to detect Cobalt Strike C&C traffic, the malicious traffic from other sources has been labeled as legitimate.

The following embodiments are combinable.

Therefore, in one embodiment of the disclosure an example method of detecting malicious network traffic includes analyzing, via a trained machine learning model, at least timing and flow duration features of traffic flow features extracted from monitored network traffic, the at least timing and flow duration features independent of content of the monitored network traffic; and predicting, via the trained machine learning model, from the analyzed at least timing and flow duration features that a cyber-attack has occurred or is occurring.

In another embodiment of the method, extracting from monitored network traffic the plurality of traffic flow features.

In another embodiment of the method, further saving the extracted plurality of traffic flow features to be available for later retrieval.

In another embodiment of the method, further grouping trace data of the monitored network traffic based on connections between first and second hosts, where the first host initiates connections and the second host participates in the connections; and the analyzing further including, for each connection of a number of connections between the first and second hosts, analyzing a duration of the connection, exfiltration of the second host compared to the first host during the connection, and interval timing of activity of the first host during the connection.

In another embodiment of the method, further analyzing, for each connection of a number of connections between the first and second hosts, a connection state of the connection to determine the interval timing of activity of the first host during the connection.

In another embodiment of the method, further analyzing, for each connection of a number of connections between the first and second hosts, one or more of a transport layer protocol of the connection, an identification of an application protocol sent over the connection, first payload bytes sent by the first host, second payload bytes sent by the second host, a state history of connections between the first host and the second host, a first number of packets sent by the first host, a second number of packets sent by the second host, a first number of IP level bytes sent by the first host, and a second number of IP level bytes sent by the second host.

In another embodiment of the method, further analyzing, for each connection of a number of connections between the first and second hosts, a transport layer protocol of the connection and an identification of an application protocol sent over the connection.

In another embodiment of the method, further analyzing, for each connection of a number of connections between the first and second hosts, one or more of a connection state of the connection to determine the interval timing of activity of the first host during the connection, first payload bytes sent by the first host, second payload bytes sent by the second host, a state of the connection, a state history of connections between the first host and the second host, a first number of packets sent by the first host, a second number of packets sent by the second host, a first number of IP level bytes sent by the first host, and a second number of IP level bytes sent by the second host.

In another embodiment of the method, further including training to generate the trained machine learning model, the training including: evaluating a plurality of machine learning models based on a plurality of performance metrics; selecting a machine learning model of the plurality of machine learning models having at least two favorable metrics of the plurality of performance metrics; and training the selected machine learning model on a training dataset to generate the trained machine learning model.

In another embodiment of the method, where the evaluating the plurality of machine learning models and the selecting the machine learning model includes: determining for each of the plurality of machine learning models evaluated an accuracy metric, a precision metric, a true positive rate (TPR) metric, a false positive rate (FPR) metric and an F1 score metric based on the precision metric and the TPR; and selecting the machine learning model of the plurality of machine learning models having a favorable ratio of a true positive rate (TPR) to a false positive rate.

In another embodiment of the method, where the plurality of machine learning models include one or more of a supervised model and an unsupervised model.

In another embodiment of the method, where the plurality of machine learning models include one or more of a random forest model, an artificial neural network model, a linear support vector machine, a naïve Bayes model, and a K-Means clustering algorithm.

In another embodiment of the method, where training the selected machine learning model includes training the machine learning model on a mixture of actual malicious traffic and normal traffic training datasets.

In another embodiment of the method, where the monitored network traffic includes encrypted or unencrypted content.

Therefore, in one embodiment of the disclosure a further method of training a machine learning model includes evaluating a plurality of machine learning models based on a plurality of performance metrics of timing and flow duration features of a plurality of traffic flow features extracted from monitored network traffic and analyzed, the evaluating including determining for each of the plurality of machine learning models evaluated at least a true positive rate (TPR) metric and a false positive rate (FPR) metric; selecting a machine learning model of the plurality of machine learning models having a favorable performance metric of the plurality of performance metrics including a favorable ratio of the true positive rate (TPR) to the false positive rate (FPR); and training the selected machine learning model on a training dataset to generate the trained machine learning model.

In another embodiment of the method, the evaluating further including determining one or more of an accuracy metric, a precision metric, and an F1 score metric based on the precision metric and the TPR.

In another embodiment of the method, where the plurality of machine learning models include one or more of a random forest model, an artificial neural network model, a linear support vector machine, a naïve Bayes model, and a K-Means clustering algorithm.

In another embodiment of the method, where training the selected machine learning model includes training the machine learning model on a mixture of actual malicious traffic and normal traffic training datasets.

Therefore, in one embodiment of the disclosure, an example system includes an analyzer configured to analyze, via a trained machine learning model, at least timing and flow duration features of a plurality of traffic flow features extracted from monitored network traffic, the at least timing and flow duration features independent of content of the monitored network traffic; and a predictor configured predict, via the trained machine learning model, from the analyzed at least timing and flow duration features of the plurality of traffic flow features that a cyber-attack has occurred or is occurring.

In another embodiment of the system, the analyzer is further configured to group trace data of the monitored network traffic based on connections between first and second hosts, where the first host initiates connections and the second host participates in the connections; and analyze, for each connection of a number of connections between the first and second hosts, a duration of the connection, exfiltration of the second host compared to the first host during the connection, and interval timing of activity of the first host during the connection.

In another embodiment of the system, the analyzer further configured to analyze, for each connection of the number of connections between the first and second hosts, a connection state of the connection to determine the interval timing of activity of the first host during the connection.

In another embodiment of the system, the analyzer further configured to analyze, for each connection of the number of connections between the first and second hosts, one or more of a transport layer protocol of the connection, an identification of an application protocol sent over the connection, first payload bytes sent by the first host, second payload bytes sent by the second host, a state history of connections between the first host and the second host, a first number of packets sent by the first host, a second number of packets sent by the second host, a first number of IP level bytes sent by the first host, and a second number of IP level bytes sent by the second host.

In another embodiment of the system, the analyzer further configured to analyze, for each connection of the number of connections between the first and second hosts, a transport layer protocol of the connection and an identification of an application protocol sent over the connection.

In another embodiment of the system, the analyzer further configured to analyze, for each connection of the number of connections between the first and second hosts, one or more of a connection state of the connection to determine the interval timing of activity of the first host during the connection, first payload bytes sent by the first host, second payload bytes sent by the second host, a state of the connection, a state history of connections between the first host and the second host, a first number of packets sent by the first host, a second number of packets sent by the second host, a first number of IP level bytes sent by the first host, and a second number of IP level bytes sent by the second host.

In another embodiment of the system, further including a monitor configured to monitor network traffic in a network system and extract from the monitored network traffic trace data having the plurality of traffic flow features.

In another embodiment of the system, further including a database, where the extracted plurality of traffic flow features are saved to the database and available for retrieval by the analyzer.

In another embodiment of the system, the monitored network traffic includes encrypted or unencrypted content.

In another embodiment of the system, further including a training module configured to generate the trained machine learning model by evaluation of a plurality of machine learning models based on a plurality of performance metrics; selection of a machine learning model of the plurality of machine learning models having at least two favorable metrics of the plurality of performance metrics; and training of the selected machine learning model on a training dataset to generate the trained machine learning model.

In another embodiment of the system, where the evaluation of the plurality of machine learning models and the selecting the machine learning model includes: determination for each of the plurality of machine learning models evaluated at least a true positive rate (TPR) metric and a false positive rate (FPR) metric; and selection of the machine learning model of the plurality of machine learning models having a favorable ratio of a true positive rate (TPR) to a false positive rate.

In another embodiment of the system, where the evaluation of the plurality of machine learning models further includes determination for each of the plurality of machine learning models evaluated an accuracy metric, a precision metric, and an F1 score metric based on the precision metric and the TPR.

In another embodiment of the system, the training module trains the machine learning model on a mixture of actual malicious traffic and normal traffic training datasets.

In another embodiment of the system, where the plurality of machine learning models include one or more of a random forest model, an artificial neural network model, a linear support vector machine, a naïve Bayes model, and a K-Means clustering algorithm.

While implementations of the disclosure are susceptible to embodiment in many different forms, there is shown in the drawings and will herein be described in detail specific embodiments, with the understanding that the present disclosure is to be considered as an example of the principles of the disclosure and not intended to limit the disclosure to the specific embodiments shown and described. In the description above, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. References to items in the singular should be understood to include items in the plural, and vice versa, unless explicitly stated otherwise or clear from the text.

As used herein, the term “configured to,” when applied to an element, means that the element may be designed or constructed to perform a designated function, or that is has the required structure to enable it to be reconfigured or adapted to perform that function.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” “for example,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus, device, system, etc. may be used interchangeably in this text.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations conducted can often be varied, additional operations can be added, or operations can be deleted without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A method of detecting malicious network traffic, comprising:
analyzing, via a trained machine learning model, at least timing and flow duration features of a plurality of traffic flow features extracted from monitored network traffic, the at least timing and flow duration features independent of content of the monitored network traffic; and
predicting, via the trained machine learning model, from the analyzed at least timing and flow duration features of the plurality of traffic flow features that a cyber-attack has occurred or is occurring.

2. The method of claim 1, further comprising extracting from monitored network traffic the plurality of traffic flow features.

3. The method of claim 1, further comprising:
grouping trace data of the monitored network traffic based on connections between first and second hosts, where the first host initiates connections and the second host participates in the connections; and
the analyzing further including, for each connection of a number of connections between the first and second hosts, analyzing a duration of the connection, exfiltration of the second host compared to the first host during the connection, and interval timing of activity of the first host during the connection.

4. The method of claim 3 further analyzing, for each connection of a number of connections between the first and second hosts, a connection state of the connection to determine the interval timing of activity of the first host during the connection.

5. The method of claim 4, further analyzing, for each connection of a number of connections between the first and second hosts, one or more of a transport layer protocol of the connection, an identification of an application protocol sent over the connection, first payload bytes sent by the first host, second payload bytes sent by the second host, a state history of connections between the first host and the second host, a first number of packets sent by the first host, a second number of packets sent by the second host, a first number of IP level bytes sent by the first host, and a second number of IP level bytes sent by the second host.

6. The method of claim 3, further analyzing, for each connection of a number of connections between the first and second hosts, a transport layer protocol of the connection and an identification of an application protocol sent over the connection.

7. The method of claim 6, further analyzing, for each connection of a number of connections between the first and second hosts, one or more of a connection state of the connection to determine the interval timing of activity of the first host during the connection, first payload bytes sent by the first host, second payload bytes sent by the second host, a state of the connection, a state history of connections between the first host and the second host, a first number of packets sent by the first host, a second number of packets sent by the second host, a first number of IP level bytes sent by the first host, and a second number of IP level bytes sent by the second host.

8. The method of claim 1, further comprising:
training to generate the trained machine learning model, the training including:
evaluating a plurality of machine learning models based on a plurality of performance metrics;
selecting a machine learning model of the plurality of machine learning models having at least two favorable metrics of the plurality of performance metrics; and
training the selected machine learning model on a training dataset to generate the trained machine learning model.

9. The method of claim 8, where the evaluating the plurality of machine learning models and the selecting the machine learning model includes:
determining for each of the plurality of machine learning models evaluated an accuracy metric, a precision metric, a true positive rate (TPR) metric, a false positive rate (FPR) metric and an F1 score metric based on the precision metric and the TPR; and
selecting the machine learning model of the plurality of machine learning models having a favorable ratio of a true positive rate (TPR) to a false positive rate.

10. The method of claim 8, where training the selected machine learning model includes training the machine learning model on a mixture of actual malicious traffic and normal traffic training datasets.

11. The method of claim 1, where the monitored network traffic includes encrypted or unencrypted content.

12. A detection system, comprising:
an analyzer configured to analyze, via a trained machine learning model, at least timing and flow duration features of a plurality of traffic flow features extracted from monitored network traffic, the at least timing and flow duration features independent of content of the monitored network traffic; and
a predictor configured predict, via the trained machine learning model, from the analyzed at least timing and flow duration features of the plurality of traffic flow features that a cyber-attack has occurred or is occurring.

13. The detection system of claim 12, the analyzer further configured to:
group trace data of the monitored network traffic based on connections between first and second hosts, where the first host initiates connections and the second host participates in the connections; and
analyze, for each connection of a number of connections between the first and second hosts, a duration of the connection, exfiltration of the second host compared to the first host during the connection, and interval timing of activity of the first host during the connection.

14. The detection system of claim 13, the analyzer further configured to analyze, for each connection of the number of connections between the first and second hosts, a connection state of the connection to determine the interval timing of activity of the first host during the connection.

15. The detection system of claim 14, the analyzer further configured to analyze, for each connection of the number of connections between the first and second hosts, one or more of a transport layer protocol of the connection, an identification of an application protocol sent over the connection, first payload bytes sent by the first host, second payload bytes sent by the second host, a state history of connections between the first host and the second host, a first number of packets sent by the first host, a second number of packets sent by the second host, a first number of IP level bytes sent by the first host, and a second number of IP level bytes sent by the second host.

16. The detection system of claim 13, the analyzer further configured to analyze, for each connection of the number of connections between the first and second hosts, a transport layer protocol of the connection and an identification of an application protocol sent over the connection.

17. The detection system of claim 16, the analyzer further configured to analyze, for each connection of the number of connections between the first and second hosts, one or more of a connection state of the connection to determine the interval timing of activity of the first host during the connection, first payload bytes sent by the first host, second payload bytes sent by the second host, a state of the connection, a state history of connections between the first host and the second host, a first number of packets sent by the first host, a second number of packets sent by the second host, a first number of IP level bytes sent by the first host, and a second number of IP level bytes sent by the second host.

18. The detection system of claim 12, further comprising:
a monitor configured to monitor network traffic in a network system and extract from the monitored network traffic trace data having the plurality of traffic flow features.

19. A method of training a machine learning model, comprising:
evaluating a plurality of machine learning models based on a plurality of performance metrics of timing and flow duration features of a plurality of traffic flow features extracted from monitored network traffic and analyzed, the evaluating including determining for each of the plurality of machine learning models evaluated at least a true positive rate (TPR) metric and a false positive rate (FPR) metric;
selecting a machine learning model of the plurality of machine learning models having a favorable performance metric of the plurality of performance metrics including a favorable ratio of the true positive rate (TPR) to the false positive rate (FPR); and
training the selected machine learning model on a training dataset to generate the trained machine learning model.

20. The method of claim 19, the evaluating further including determining one or more of an accuracy metric, a precision metric, and an F1 score metric based on the precision metric and the TPR.
